(19) United States
(12) Patent Application Publication
(10) Pub. No.: US 2014/0166796 A1
(43) Pub. Date: Jun. 19, 2014

(54) CRUSHER-BREAKER GROUP FOR SCRAP METAL

(71) Applicant: Cesare Bonfiglioli, Castello D'Argile (BO) (IT)

(72) Inventor: Cesare Bonfiglioli, Castello D'Argile (BO) (IT)

(21) Appl. No.: 14/104,107

(22) Filed: Dec. 12, 2013

(30) Foreign Application Priority Data
Dec. 13, 2012 (IT) RE2012A000093

(51) Int. Cl. B02C 19/00; B02C 1/00

(52) U.S. Cl. CPC B02C 19/0062; B02C 1/005
USPC 241/262

(57) ABSTRACT

A crusher-breaker group for scrap metal is provided and includes a press configured to reduce a volume of the scrap communicating with a hammer mill via a supply channel, in which the press includes a shearing device configured to separate the scrap pressed into parallelepiped bales and advance the bales along a work plane which constitutes an initial part of the supply channel and opens directly into the cage of the mill.

### FIELD OF THE INVENTION

The present invention relates in general to crushing and breaking of scrap metal, such as for example automobile bodies or parts thereof or other like products.

### BACKGROUND

In the prior art, the crushing-breaking of these and like products is carried out using hammer mills, to which the products are supplied continuously after having been subjected to a compacting operation.

The scrap is placed in a large hopper, from which it falls by gravity into an underlying supply channel.

Suitable baler means reduce the volume of the scrap and advance them at the same time into the cage of the hammer mill, thus subjecting them to a compacting action.

Also known are plants in which a wall of the hopper can rotate about a horizontal axis in order to subject the scrap advancing in the supply channel to a substantially vertical compression against the base of the supply channel, in order to perform a first partial compacting of the scrap.

Plant of this type is known and described for example in Italian Patent Application no. RE2001A0000032 in the name of the present applicant.

The scrap is sent to the mill in the form of a continuous bale having a quadrangular section.

The bale can comprise recipients containing residues of combustible gases (canisters) which when subjected to the action of the mill without being previously broken up, can cause dangerous explosions.

The direct supply of the continuous belt of the scrap to the mill exhibits a further drawback in that in a case of a temporary halt of the mill a small quantity of scrap remains inside the mill, making subsequent re-start problematic. The presence of scrap residues in the mill at the moment of start-up, before normal running speed of the rotor has been reached, indeed causes serious damage to the mill.

This drawback has been eliminated by the invention described in Italian patent no. IT 1 328 584, in the name of the same applicant, in which stop means are included of the flow of scrap, located immediately upstream of the inlet opening to the mill, which are activated as soon as the mill is stopped such as to prevent any presence of scrap therein when the mill is re-started later.

The presence of the stop means considerably complicates the construction and the functioning of the mill.

The aim of the present invention is to disclose a plant for receiving large-dimension scrap metal, such as vehicle bodies or parts thereof, in order to transform them into parallelepiped bales of pressed scrap which can be directly supplied to the mill after having been subjected to a shearing operation which guarantees a cold-opening of any recipients that might contain residues of combustible gas, and thus obviates the need for stop means.

### SUMMARY

The aim is attained with a plant having the characteristics recited in the independent claim.

The invention substantially comprises a vertical-axis hopper provided with two opposite and fixed vertical walls between which a fixed inclined wall is positioned, converging in a downwards direction.

A mobile wall is positioned opposite the inclined wall, inclined in an opposite direction so that the two inclined walls converge in a downwards direction.

Suitable activating means cause translation of the mobile inclined wall of the hopper towards the fixed inclined wall, maintaining it parallel to itself.

This causes compacting of the material, at the same time reducing the mouth of the hopper in the movement direction of the wall.

A channel is located below the mouth of the hopper, in a perpendicular direction to the movement direction of the wall, a dimension of which is equal to a dimension of the hopper mouth.

A block is located internally of the channel, having a same transversal section as the channel, activated by suitable actuator means to move below the mobile wall up to completely obstructing the hopper mouth.

The block moves over a first section together with the mobile wall and then proceeds at least up to blocking the hopper mouth.

During the return travel the block moves over a first section up to being flush with the mobile wall of the hopper, and over a second section moves together with the mobile wall of the hopper.

The base of the fixed part of the hopper and the corner of the block on the side facing the hopper mouth comprise a shearing edge which can be made in a separate part.

The channel directly heads up to a known hammer mill in which bales are entered one at a time.

### BRIEF DESCRIPTION OF THE DRAWINGS

The constructional and functional advantages and characteristics of the invention will clearly emerge from the detailed description that follows which, with the aid of the accompanying drawings, illustrates a preferred embodiment given by way of non-limiting example.

In the drawings the hammer mill is only schematically represented, as the characteristics thereof are well known to specialist technicians in the sector.

FIG. 1 illustrates a vertical section of the press in a plane parallel to the two opposite fixed walls of the hopper, in the start operating position, with the load of scrap.

FIG. 2 is FIG. 1 with the mobile wall and the underlying bale in the position of maximum advancement of the mobile wall, with the scrap bale compacted.

FIG. 3 shows FIG. 2 with the mobile wall retracted in order for the bale of compacted scrap to fall.

FIG. 4 shows FIG. 3 with the mobile wall advanced in order to compress the bale of scrap that has fallen downwards.

FIG. 5 shows FIG. 4 in which the block with the shearing edge underlying the mobile wall of the hopper is further advanced such as to close the lower mouth of the hopper.

FIG. 6 shows FIG. 5 with the mobile wall newly retracted in order to allow the mass of scrap in the hopper to fall downwards.

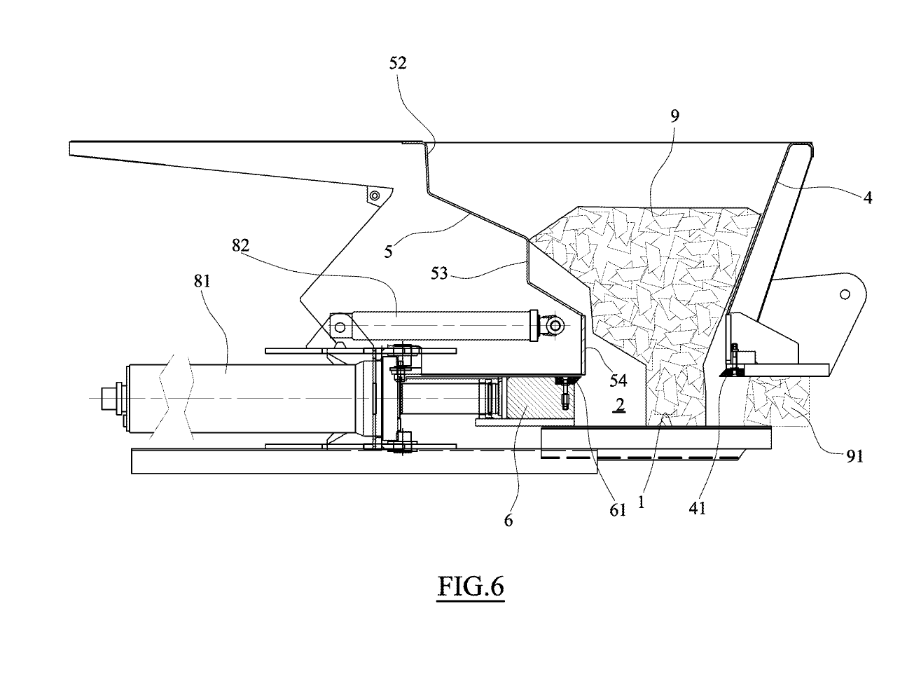

FIG. 7 shows the invention complete with the mill positioned in the operating position of FIG. 1.

### DETAILED DESCRIPTION OF THE PREFERRED EMBODIMENTS

The figures schematically illustrate the work plane 1 at the sides of which two fixed lateral walls 2 are shown (of which only one is visible in the figures) which with the plane 1 form the initial part of the supply channel 7.

A fixed inclined wall 4 is located between the walls 2, the lower edge of which comprises a shearing edge 41 located at a distance from the plane 1.

The mobile wall 5 is located in front of the fixed wall 4, which mobile wall 5 is slidable on two lateral guides (not shown), in order to move parallel to itself towards the fixed wall 4.

The mobile wall 5 overlies a block 6 located between the base of the wall 5 and the work plane 1; the front upper edge 61 of the block 6 is a shearing edge.

Means (not illustrated) are provided between the opposite walls 2, for supporting the body of a first double-acting hydraulic piston cylinder group 81 a stem of which is fixed to the block 6, as well as to support the body of a second double-acting hydraulic piston cylinder group 82 a stem of which is fixed to the mobile wall 5.

The mobile wall 5 converges downwards with the fixed wall 4, and comprises vertical tracts 52, 53 and 54 connected by inclined sections.

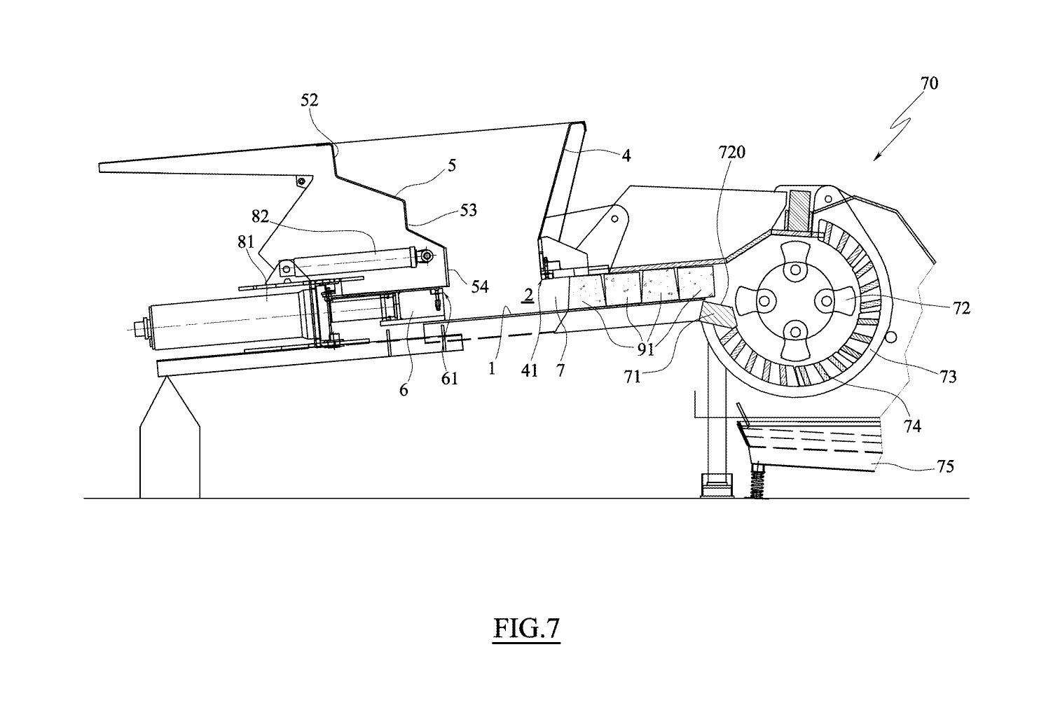

The supply channel 7 of the scrap, the initial tract of which is constituted by the work plane 1 and the opposite walls 2, heads up to the hammer mill (FIG. 7).

In particular, the channel 7 is slightly inclined upwards, and at the end thereof close to the mill has the bottom thereof connected to a crosspiece 71 of the mill cage functioning as an anvil for the hammers 72 of the mill.

The upper surface 720 of the crosspiece 71 effectively continues the supply channel but is slightly downwardly inclined.

The usual arches 73 of the mill are headed up to the crosspiece 71, the arches 73 are joined by equidistant crosspieces.

Further details are not provided of the hammer mill 70, which is well known to technical experts in the field.

A recipient 75 is located below the mill 70 for collecting the milled scrap.

The functioning of the invention is as follows.

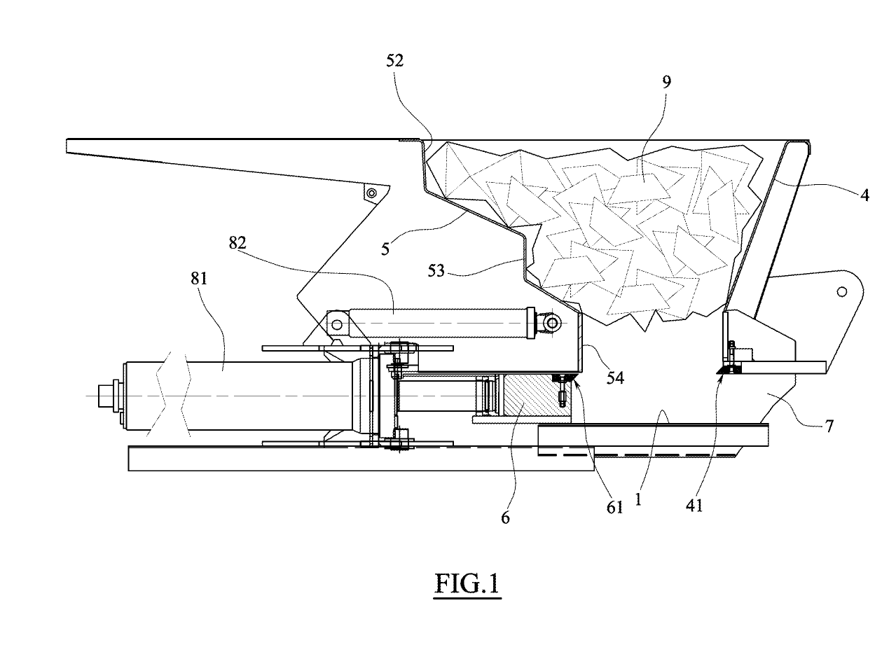

At the start of the breaking operation, the machine exhibits the configuration of FIG. 1 and FIG. 7, and the mass 9 of scrap is sent into the hopper made available by the walls 2, 4 and 5, without contacting with the plane 1, remaining supported on the walls 4 and 5.

When the mass of scrap has been introduced, the piston cylinder group 82 is activated up to compacting the mass of scrap between the walls 4 and 5.

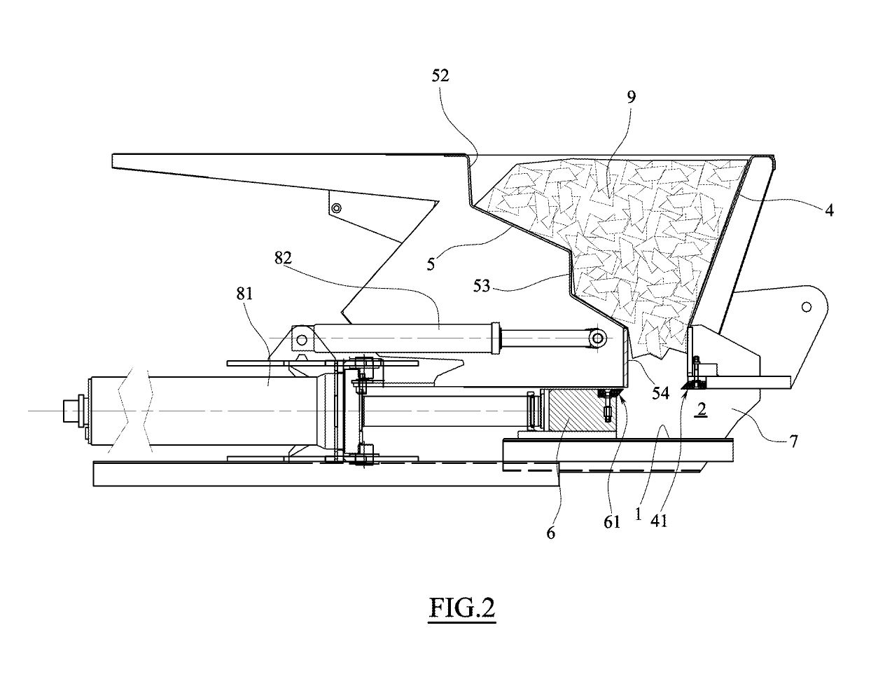

Despite the compression, the mass 9 does not rest on the plane 1 (figure 2).

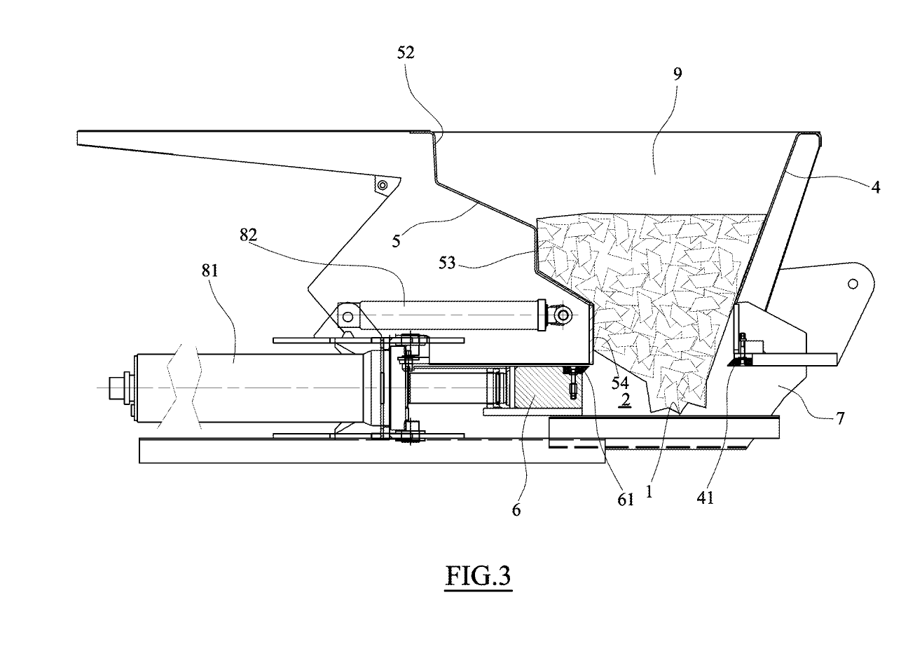

At this point the mobile wall 5 is distanced, once more by means of the piston cylinder group 82, whereupon the mass of scrap can descend by gravity and rest on the work plane 1 (FIG. 3).

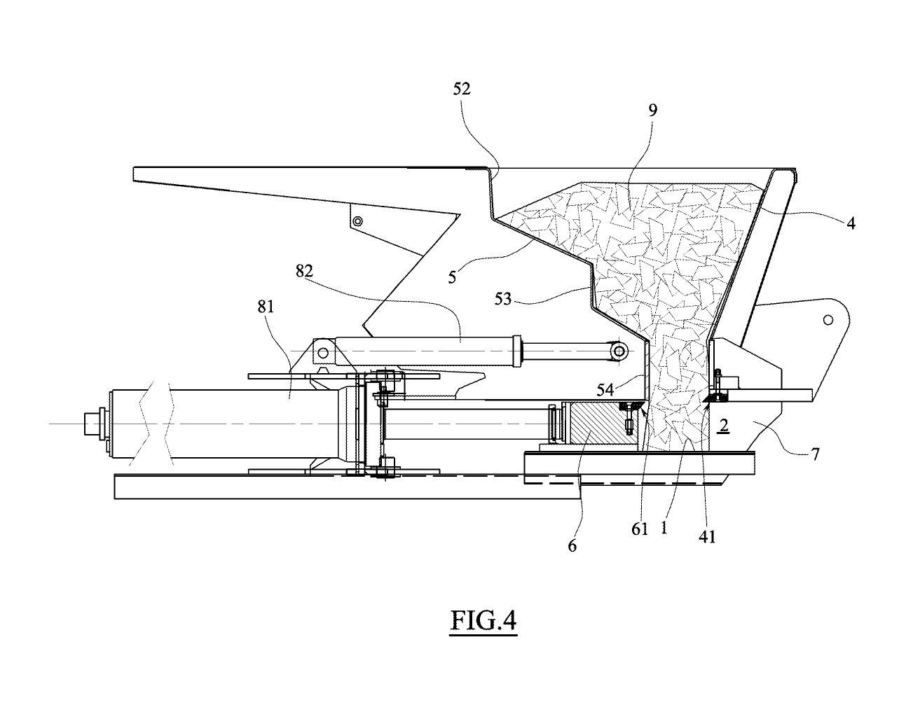

The piston cylinder groups 81 and 82 are then contemporaneously activated, which further compress the scrap up to the point where the machine takes on the configuration of FIG. 4; the mobile wall 5 and the block 6 in this configuration are advanced by a same quantity.

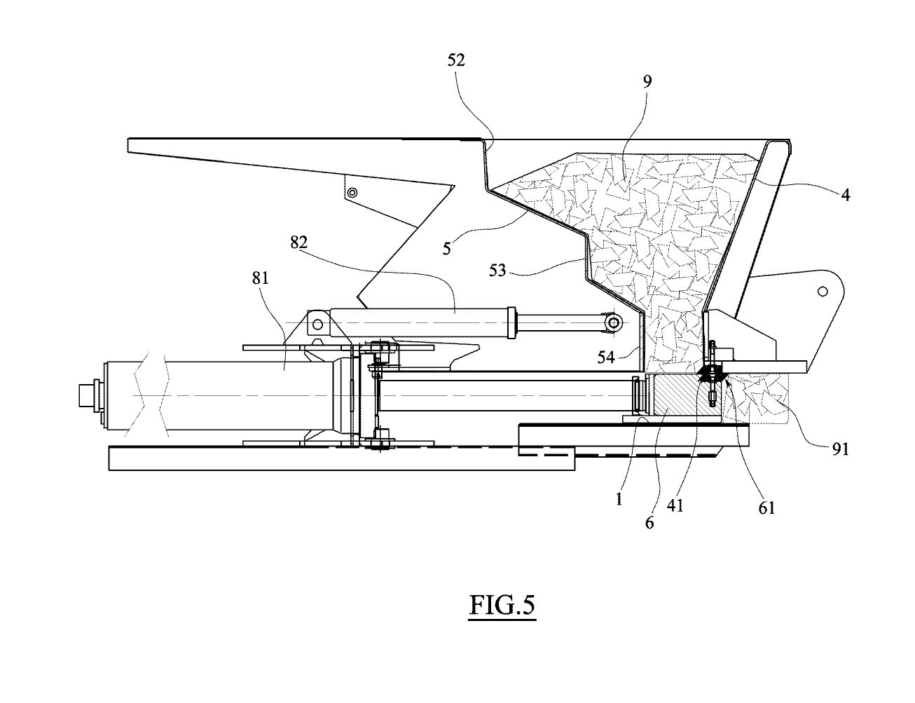

The next step includes a further advancing of the block 6, by means of the piston cylinder group 81, up to when the block 6 completely obstructs the lower mouth of the hopper, and the shearing edge 61 does not pass beyond the shearing edge 41 of the fixed wall 4 (FIG. 5).

During this step the compacted lower portion 91 separates from the mass of scrap 9, due to the action of the shearing action performed by the shearing edges 41 and 61.

The further advancing of the block 6 pushes the portion 91 out of the work plane 1, where it advances in the supply channel up to the mill.

The subsequent retraction of the mobile wall 5 and the underlying block 6 enables the bale of scrap to fall up to resting on the work plane, and the cycle repeats.

The bales 91 of scrap progressively created by the press are pushed one by another up to the cage of the mill, where they fall one by one.

The preceding description is understood to relate to a preferred example of actuation of the invention, and any modifications and improvements can be made without forsaking the protective scope defined by the following claims.

1. A crusher-breaker group for scrap metal, comprising a press (4, 5) configured to reduce a volume of the scrap (9) communicating with a hammer mill (70) via a supply channel (7), the press (4, 5) comprises a substantially vertical-axis hopper overlying a work plane (1), an inclined fixed wall (4), a lower edge of which is situated at a distance from the work plane (1), and an inclined mobile wall (5) located in front of the inclined fixed wall (4) a lower edge of which is situated at a distance from the work plane (1), a block (6) located below the mobile wall (5) which occupies a space between the lower edge of the mobile wall (5) and the work plane (1), an actuator device (81, 82) for sliding the mobile wall (5) and the underlying block (6) independently of one another, in order to displace the mobile wall (5) and the underlying block (6) towards and away from the inclined fixed wall (4), in which the lower edge of the inclined fixed wall (4) and the front upper edge of the block (6) comprise a shearing edge (41, 61).

2. The crusher-breaker group for scrap metal of claim 1, wherein the actuator device (81, 82) comprises a double-acting hydraulic piston-cylinder group.

3. The crusher-breaker group for scrap metal of claim 2, wherein the actuator device comprises a first actuator(81) located between a frame of the press and the mobile wall (5) and a second actuator device (82) located between the frame and the block (6) underlying the mobile wall (5).

4. The crusher breaker group of claim 4, wherein the second actuator (82) has sufficient travel to bring a rear edge of the block (6) beyond the lower shearing edge (41) of the fixed wall (4).
